(19) United States
(12) Patent Application Publication
(10) Pub. No.: US 2020/0311831 A1
(43) Pub. Date: Oct. 1, 2020

(54) GAS FEE OVERDRAWING METHOD BASED ON COMPOUND INTERNET OF THINGS (IOT) AND IOT SYSTEM

(71) Applicant: Chengdu Qinchuan Technology Development Co., Ltd., Chengdu (CN)

(72) Inventor: Zehua SHAO, Chengdu (CN)

(21) Appl. No.: 16/366,881

(22) Filed: Mar. 27, 2019

(51) Int. Cl. G06Q 50/06; G06Q 20/40

(52) U.S. Cl. CPC G06Q 50/06; G06Q 20/4037; G06Q 20/40145

(57) ABSTRACT

The present invention relates to the field of Internet of Things (IoT), and provides a gas fee overdrawing method based on a compound IoT and an IoT system. By providing a card reader or a fingerprint recognition device on a gas meter, when a balance of the gas meter is insufficient and a user is inconvenient to recharge the balance of the gas meter, the user sends an overdrawing request to a management platform via the gas meter by swiping a card or fingerprint, and the user may also send the overdrawing request to the management platform via a user sub-platform, and then the management platform sends a corresponding overdrawn balance to the gas meter according to the credit of the user; and thus, the gas can be used by the user.

### TECHNICAL FIELD

The present invention relates to the field of Internet of Things (IoT), and in particular to a gas fee overdrawing method based on a compound IoT and an IoT system.

### BACKGROUND

Along with ever-changing development of an IoT technology, various instruments and meters, such as a gas meter, also enter the sector of an IoT. A traditional gas meter has been gradually replaced by an IoT intelligent gas meter. At present, a manner for paying a gas fee is to recharge a recharge card and then insert the recharge card into a gas meter, thereby completing the recharge of the gas fee. However, due to a limited recharge amount, after a balance read by the gas meter on the recharge card is used up by a user, if the gas meter is not recharged in time, consequences such as gas stoppage will be caused to seriously affect the normal gas usage of the user.

### SUMMARY

In view of this, an objective of the present invention is to provide a gas fee overdrawing method based on a compound IoT and an IoT system to improve the above-mentioned problem.

To this end, the technical solutions adopted by the present invention are as follows:

According to a first aspect, the present invention provides a gas fee overdrawing method based on a compound IoT; the method is applied to an IoT system; the IoT system includes a plurality of user sub-platforms, a plurality of service sub-platforms, a management platform, a plurality of sensor network sub-platforms and a plurality of object sub-platforms; the plurality of object sub-platforms each include a gas meter; and the method includes: initiating, by one of the plurality of user sub-platforms, an overdrawing request to one of the plurality of service sub-platforms, or initiating, by one of the plurality of gas meters, the overdrawing request to one of the plurality of sensor network sub-platforms; obtaining, by the management platform, the overdrawing request from one of the plurality of service sub-platforms or from one of the plurality of sensor network sub-platforms; querying, by the management platform, the credit of a user according to the overdrawing request and determining an overdrawn amount; and sending, by the management platform, the overdrawn amount to a gas meter corresponding to the overdrawing request via one of the plurality of sensor network sub-platforms.

Further, the method includes: upon the reception of the overdrawn amount, feeding, by a gas meter, a confirmation message to the management platform via one of the sensor network sub-platforms.

Further, the plurality of service sub-platforms include operator service platforms and a recharge platform; and after the management platform receives the confirmation message fed back by the gas meter, the method further includes: obtaining, by the management platform, a payment amount according to the credit and the overdrawn amount, and sending the credit, the overdrawn amount and the payment amount to a user sub-platform corresponding to the overdrawing request via the plurality of operator service platforms; and contributing, by the user sub-platform, the payment amount via the recharge platform within a preset time.

Further, the step of initiating, by one of the plurality of user sub-platforms, an overdrawing request to one of the plurality of service sub-platforms specifically includes: initiating, by one of the plurality of user sub-platforms, the overdrawing request to one of the plurality of service sub-platforms via an Application (APP) according to an operation instruction of a user, the overdrawing request including an Identification (ID) number of a gas meter of which the gas fee needs to be overdrawn and identification information of the user.

Further, the plurality of gas meters are further respectively and electrically connected with a card reader or a fingerprint recognition device; the card reader and the fingerprint recognition device are configured to verify the identity information of the user; and before the step of initiating, by one of the plurality of gas meters, the overdrawing request to one of the plurality of sensor network sub-platforms, the method further includes: initiating, by a user, an instruction to a gas meter by swiping a card on a card reader or performing fingerprint verification on a fingerprint recognition device; and initiating, by the gas meter, an overdrawing request to one of the plurality of sensor network sub-platforms, the overdrawing request including an ID number of the gas meter and identity information of the user.

According to a second aspect, the present invention further provides an IoT system; the IoT system includes a plurality of user sub-platforms, a plurality of service sub-platforms, a management platform, a plurality of sensor network sub-platforms and a plurality of object sub-platforms; the plurality of object sub-platforms each include a gas meter; each of the user sub-platforms is configured to initiate an overdrawing request to one of the plurality of service sub-platforms; each of the gas meters is configured to send the overdrawing request to one of the plurality of sensor network sub-platforms; and the management platform is configured to obtain the overdrawing request from one of the plurality of service sub-platforms or from one of the plurality of sensor network sub-platforms, query the credit of a user according to the overdrawing request and determine an overdrawn amount, and send the overdrawn amount to a gas meter corresponding to the overdrawing request via one of the plurality of sensor network sub-platforms.

Further, each of the gas meters is configured to feed, upon the reception of the overdrawn amount, a confirmation message to the management platform via one of the sensor network sub-platforms.

Further, the plurality of service sub-platforms include operator service platforms and a recharge platform; and the management platform is further configured to obtain a payment amount according to the credit and the overdrawn amount, and send the credit, the overdrawn amount and the payment amount to a user sub-platform corresponding to the overdrawing request via the plurality of operator service platforms; and each of the user sub-platforms is further configured to contribute the payment amount via the recharge platform within a preset time.

Further, each of the user platforms is specifically configured to initiate the overdrawing request to one of the plurality of service sub-platforms via an APP according to an operation instruction of a user, the overdrawing request including an ID number of a gas meter of which the gas fee needs to be overdrawn and identification information of the user.

Further, the plurality of gas meters are respectively and electrically connected with a card reader or a fingerprint recognition device; the card reader and the fingerprint recognition device are configured to verify the identity information of the user; a user initiates an instruction to a gas meter by swiping a card on a card reader or performing fingerprint verification on a fingerprint recognition device; and the gas meter initiates an overdrawing request to one of the plurality of sensor network sub-platforms, the overdrawing request including an ID number of the gas meter and identity information of the user.

The present invention provides a gas fee overdrawing method based on a compound IoT and an IoT system. The method is applied to the IoT system; the IoT system includes a plurality of user sub-platforms, a plurality of service sub-platforms, a management platform, a plurality of sensor network sub-platforms and a plurality of object sub-platforms; and the plurality of object sub-platforms each include a gas meter. The method includes: initiating, by one of the plurality of user sub-platforms, an overdrawing request to one of the plurality of service sub-platforms, or initiating, by one of the plurality of gas meters, the overdrawing request to one of the plurality of sensor network sub-platforms; obtaining, by the management platform, the overdrawing request from one of the plurality of service sub-platforms or from one of the plurality of sensor network sub-platforms, the overdrawing request including the credit of a user; determining, by the management platform, an overdrawn amount according to the credit of the user; and sending, by the management platform, the overdrawn amount to a gas meter corresponding to the overdrawing request via one of the plurality of sensor network sub-platforms.

According to the gas fee overdrawing method based on the compound IoT and the IoT system provided by the present invention, by providing a card reader or a fingerprint recognition device on a gas meter, when a balance of the gas meter is insufficient and a user is inconvenient to recharge the balance of the gas meter, the user sends an overdrawing request to the management platform via the gas meter by swiping a card or swiping a fingerprint, and the user may also send the overdrawing request to the management platform via a user sub-platform, and then the management platform sends a corresponding overdrawn balance to the gas meter according to the credit of the user; and thus, the gas can be used by the user. Therefore, the problem of gas stoppage to affect the normal use due to the fact that the user cannot recharge in time is solved.

To make the above objectives, characteristics and advantages of the present invention more apparent and understandable, preferred embodiments are set forth hereinafter and are described below in detail in combination with accompanying drawings.

### BRIEF DESCRIPTION OF DRAWINGS

To make the objectives, technical solutions and advantages of the embodiments of the present invention clearer, a clear and complete description of the technical solutions in the present invention will be given below in combination with the accompanying drawings in the embodiments of the present invention. Apparently, the embodiments described below are a part, but not all, of the embodiments of the present invention. Generally, a component, described and illustrated in the accompanying drawings, in the embodiments of the present invention may be disposed and designed in various different configurations. Therefore, the following detailed description concerning the embodiments of the present invention and provided in the accompanying drawings is not intended to limit a claimed scope of the present invention, but merely represents selected embodiments of the present invention. All of the other embodiments, obtained by a person of ordinary skill in the art based on the embodiments of the present invention without any inventive efforts, fall into the protection scope of the present invention.

FIG. 1 illustrates a compositional schematic diagram of an IoT system provided by an embodiment of the present invention; and

FIG. 2 illustrates a flowchart of a gas fee overdrawing method based on a compound IoT provided by an embodiment of the present invention; and

FIG. 3 illustrates a schematic diagram of a relationship between a credit and an overdrawn amount.

Numerals in the drawings: 100—IoT system; 10—user sub-platform; 20—service sub-platform; 30—management platform; 40—sensor network sub-platform; 50—object sub-platform.

### DESCRIPTION OF EMBODIMENTS

A clear and complete description of the technical solutions in the present invention will be given below in combination with the accompanying drawings in the embodiments of the present invention. Apparently, the embodiments described below are a part, but not all, of the embodiments of the present invention. Generally, a component, described and illustrated in the accompanying drawings, in the embodiments of the present invention may be disposed and designed in various different configurations. Therefore, the following detailed description concerning the embodiments of the present invention and provided in the accompanying drawings is not intended to limit a claimed scope of the present invention, but merely represents selected embodiments of the present invention. All of the other embodiments, obtained by those skilled in the art based on the embodiments of the present invention without any inventive efforts, fall into the protection scope of the present invention.

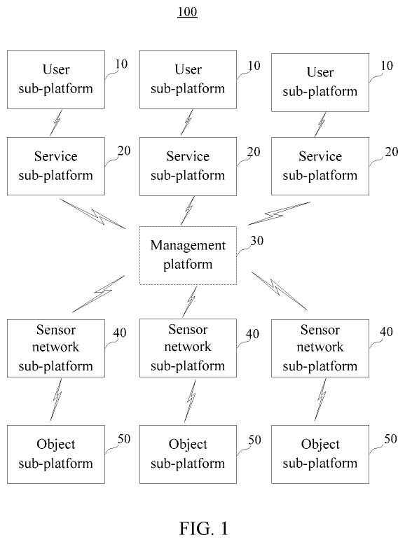

Referring to FIG. 1, a compositional schematic diagram of an IoT system provided by an embodiment of the present invention is shown. A gas fee overdrawing method based on a compound IoT provided by an embodiment of the present invention is applied to an IoT system; and the IoT system includes a plurality of user sub-platforms 10, a plurality of service sub-platforms 20, a management platform 30, a plurality of sensor network sub-platforms 40 and a plurality of object sub-platforms 50. Herein, any one of the plurality of object sub-platforms 50 may be communicatively connected with the management platform 30 via one of the plurality of sensor network sub-platforms 40 to send an overdrawing request to the management platform 30, and receive an overdrawn amount sent by the management platform 30. The plurality of object sub-platforms 50 each includes a gas meter.

The management platform 30 is communicatively connected with the plurality of service sub-platforms 20. In this embodiment, the service sub-platforms 20 may include a government service platform, a recharge platform, and a social operator service platform. The plurality of service sub-platforms 20 are communicatively connected with the plurality of user sub-platforms 10, and are configured to receive the overdrawing request sent by the user sub-platforms 10. The user sub-platforms 10 each may be a universal electronic device such as a Personal Computer (PC), a smartphone, a tablet computer, a Personal Digital Assistant (PDA) and a Mobile Internet Device (MID). In this embodiment, each of the user sub-platforms 10 is a smartphone, and one user may operate one smartphone and may be associated with one or more gas meters. One gas meter may also be associated with different smartphones, i.e., one gas meter may be controlled by a plurality of smartphones. The management platform 30 can be a management server of a gas company. According to the gas fee overdrawing method based on the compound IoT provided by this embodiment of the present invention, when a balance of a gas meter of a user is insufficient and is not recharged conveniently, a certain gas fee may be overdrawn to continuously use the gas.

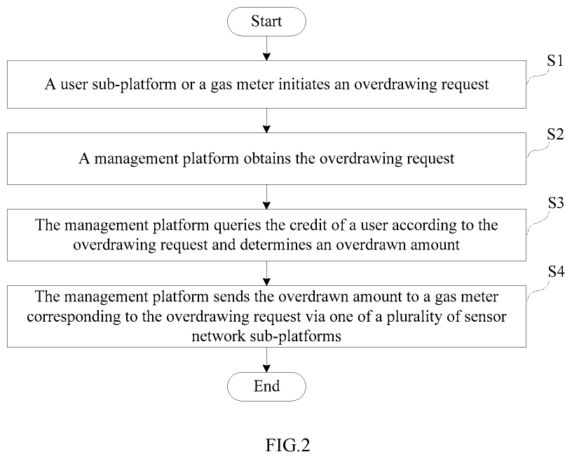

Referring to FIG. 2, a flowchart of a gas fee overdrawing method based on a compound IoT provided by an embodiment of the present invention is shown. It is to be noted that the gas fee overdrawing method based on the compound IoT provided by this embodiment of the present invention is not limited to FIG. 2 and a specific sequence set forth hereinafter. It is to be understood that, in other embodiments, the sequences of a part of steps in the gas fee overdrawing method based on the compound IoT provided by the present invention may be exchanged according to an actual demand, or a part of steps therein may also be omitted or deleted. The gas fee overdrawing method based on the compound IoT is applied to an IoT system, and the method includes the following steps:

Step S1, a user sub-platform 10 or a gas meter initiates an overdrawing request.

The manner of the user sub-platform 10 to initiate the overdrawing request may be that one of the plurality of user sub-platforms 10 sends the overdrawing request to one of the plurality of service sub-platforms 20 via an APP according to an operation instruction of a user. The overdrawing request includes an ID number of a gas meter of which the gas fee needs to be overdrawn and identification information of the user. The identity information of the user may be an account registered by the user on the APP, a mobile phone number of the user and the like.

There are at least two manners for the gas meter to initiate the overdrawing request: one is that the gas meter may be electrically connected with a card reader, the card reader may read a card such as a non-contact Integrated Circuit (IC) card and the user may directly swipe the card on the card reader, or press an “Overdraw” button on the gas meter or the card reader first and then swipe the card, so that the instruction can be initiated to the gas meter; and accordingly, the gas meter initiates the overdrawing request to one of the plurality of sensor network sub-platforms 40 according to the instruction, where the overdrawing request includes the ID number of the gas meter and the identity information of the user, and the identity information of the user may be an account number of the card.

The other is that the gas meter may be electrically connected with a fingerprint recognition device, the fingerprint recognition device may read a fingerprint of the user, where fingerprints of a plurality of members of a resident may be input in advance and corresponding identity information is input; after the user performs the fingerprint recognition on the fingerprint recognition device, the fingerprint recognition device may initiate the instruction to the connected gas meter and send the identity information of the user to the gas meter; and accordingly, the gas meter initiates the overdrawing request to one of the sensor network sub-platforms 40 according to the instruction, where the overdrawing request includes the ID number of the gas meter and the identity information of the user. The ID number of the gas meter may be associated with one or more user sub-platforms 10, and one user sub-platform 10 may also be associated with a plurality of ID numbers. The sensor network sub-platforms 40 each may be an IoT intelligent gateway, and each gas meter may correspond to one or more IoT intelligent gateways. The manners that the gas meter initiates the overdrawing request are particularly applied to a condition in which a smartphone is not used conveniently, such as a condition in which the network is turned off in the house or an old man in the house doesn't know how to use a smartphone, etc.

Step S2: a management platform 30 obtains the overdrawing request.

When the overdrawing request is initiated by the user sub-platform 10, the management platform 30 receives the overdrawing request from a service sub-platform 20. When the overdrawing request is initiated by the gas meter, the management platform 30 receives the overdrawing request from a sensor network sub-platform 40.

Step S3, the management platform 30 queries the credit of a user according to the overdrawing request and determines an overdrawn amount.

The management platform 30 may obtain the identity information of the user after obtaining the overdrawing request. In this embodiment, the manner for querying the credit of the user refers to that the management platform 30 sends the identity information of the user to a government service platform, the government service platform invokes the credit corresponding to the user and sends the credit to the management platform 30, and the management platform 30 determines the overdrawn amount according to the credit.

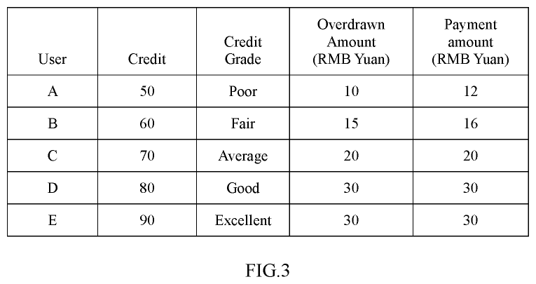

Referring to FIG. 3, a schematic diagram of a relationship between a credit and an overdrawn amount provided by an embodiment of the present invention is shown. The credits of A, B, C, D and E users invoked by the government service platform respectively are 50, 60, 70, 80 and 90, the corresponding credit grades respectively are poor, fair, average, good and excellent, and amounts overdrawn by the A, B, C, D and E users in each month may be RMB 10 Yuan, RMB 15 Yuan, RMB 20 Yuan, RMB 30 Yuan and RMB 30 Yuan respectively.

Step S4, the management platform 30 sends the overdrawn amount to a gas meter corresponding to the overdrawing request via one of a plurality of sensor network sub-platforms 40.

Upon determining the overdrawn amount according to the overdrawing request, the management platform 30 sends the overdrawn amount to the gas meter according to an ID number of the gas meter in the overdrawing request.

In this embodiment, the gas fee overdrawing method based on the compound IoT further includes the following steps: upon the reception of the overdrawn amount, the gas meter feeds a confirmation message to the management platform 30 via one of the sensor network sub-platforms 40.

The management platform 30 obtains a payment amount according to the credit and the overdrawn amount, and sends the credit, the overdrawn amount and the payment amount to a user sub-platform 10 corresponding to the overdrawing request via the plurality of operator service platforms.

The user sub-platform 10 contributes the payment amount via the recharge platform within a preset time.

Referring to FIG. 3 again, after the A, B, C, D and E users finish overdrawing, because of the different credit grades, the credits of the A user and the B user are relatively low and thus a part of fee needs to be paid additionally and the payment amounts to be contributed by the A, B, C, D and E users are 12 Yuan, RMB 16 Yuan, RMB 20 Yuan, RMB 30 Yuan and RMB 30 Yuan. The preset time may be one week, one month, two months, or the like, and if the user does not make the payment within the preset time, the government service platform will deduct a credit score of the user. It may also be appropriate that the management platform 30 establishes an overdue list, and when a user on the overdue list overdraws the gas fee in the next time, a certain score is deducted from the credit grade read by the government service platform.

In conclusion, the present invention provides a gas fee overdrawing method based on a compound IoT and an IoT system. The method is applied to the IoT system; the IoT system includes a plurality of user sub-platforms, a plurality of service sub-platforms, a management platform, a plurality of sensor network sub-platforms and a plurality of object sub-platforms; and the plurality of object sub-platforms each include a gas meter. The method includes: one of the plurality of user sub-platforms initiates an overdrawing request to one of the plurality of service sub-platforms, or one of the plurality of gas meters initiates the overdrawing request to one of the plurality of sensor network sub-platforms; the management platform obtains the overdrawing request from one of the plurality of service sub-platforms or from one of the plurality of sensor network sub-platforms, the overdrawing request including the credit of a user; the management platform determines an overdrawn amount according to the credit of the user; and the management platform sends the overdrawn amount to a gas meter corresponding to the overdrawing request via one of the plurality of sensor network sub-platforms. According to the gas fee overdrawing method based on the compound IoT and the IoT system provided by the present invention, by providing a card reader or a fingerprint recognition device on a gas meter, when a balance of the gas meter is insufficient and a user is inconvenient to recharge the balance of the gas meter, the user sends an overdrawing request to the management platform via the gas meter by swiping a card or swiping a fingerprint, and the user may also send the overdrawing request to the management platform via a mobile phone, and then the management platform sends a corresponding overdrawn balance to the gas meter according to the credit of the user; and thus, the gas can be used by the user. Therefore, the problem of gas stoppage to affect the normal use due to the fact that the user cannot recharge in time is solved.

The above are merely preferred embodiments of the present invention, and are not intended to limit the present invention. A person skilled in the art may make various modifications and changes to the present invention. Any modification, equivalent replacement, improvement and the like made within the spirit and principle of the present invention all shall be included in a scope of protection of the present invention. It should be noted that similar reference numerals and letters refer to similar items in the following drawings, and thus once an item is defined in one drawing, it does not need to be further defined and explained in the subsequent drawings.

What is claimed is:

1. A gas fee overdrawing method based on a compound Internet of Things (IoT), wherein the method is applied to an IoT system; the IoT system comprises a plurality of user sub-platforms, a plurality of service sub-platforms, a management platform, a plurality of sensor network sub-platforms and a plurality of object sub-platforms; the plurality of object sub-platforms each comprise a gas meter; and the method comprises:
initiating, by one of the plurality of user sub-platforms, an overdrawing request to one of the plurality of service sub-platforms, or initiating, by one of the plurality of gas meters, the overdrawing request to one of the plurality of sensor network sub-platforms;
obtaining, by the management platform, the overdrawing request from one of the plurality of service sub-platforms or from one of the plurality of sensor network sub-platforms;
querying, by the management platform, the credit of a user according to the overdrawing request and determining an overdrawn amount; and
sending, by the management platform, the overdrawn amount to a gas meter corresponding to the overdrawing request via one of the plurality of sensor network sub-platforms.

2. The gas fee overdrawing method based on the compound IoT according to claim 1, wherein the method further comprises: upon the reception of the overdrawn amount, feeding, by a gas meter, a confirmation message to the management platform via one of the sensor network sub-platforms.

3. The gas fee overdrawing method based on the compound IoT according to claim 2, wherein the plurality of service sub-platforms comprise operator service platforms and a recharge platform; and after the management platform receives the confirmation message fed back by the gas meter, the method further comprises:
obtaining, by the management platform, a payment amount according to the credit and the overdrawn amount, and sending the credit, the overdrawn amount and the payment amount to a user sub-platform corresponding to the overdrawing request via the plurality of operator service platforms; and
contributing, by the user sub-platform, the payment amount via the recharge platform within a preset time.

4. The gas fee overdrawing method based on the compound IoT according to claim 1, wherein the step of initiating, by one of the plurality of user sub-platforms, an overdrawing request to one of the plurality of service sub-platforms specifically comprises:
initiating, by one of the plurality of user sub-platforms, the overdrawing request to one of the plurality of service sub-platforms via an Application (APP) according to an operation instruction of a user, the overdrawing request comprising an Identification (ID) number of a gas meter of which the gas fee needs to be overdrawn and identification information of the user.

5. The gas fee overdrawing method based on the compound IoT according to claim 1, wherein the plurality of gas meters are further respectively and electrically connected with a card reader or a fingerprint recognition device; the card reader and the fingerprint recognition device are configured to verify the identity information of the user; and before the step of initiating, by one of the plurality of gas meters, the overdrawing request to one of the plurality of sensor network sub-platforms, the method further comprises:
initiating, by a user, an instruction to the gas meter by swiping a card on a card reader or performing fingerprint verification on a fingerprint recognition device; and
initiating, by the gas meter, an overdrawing request to one of the plurality of sensor network sub-platforms, the overdrawing request comprising an ID number of the gas meter and identity information of the user.

6. An Internet of Things (IoT) system, comprising a plurality of user sub-platforms, a plurality of service sub-platforms, a management platform, a plurality of sensor network sub-platforms and a plurality of object sub-platforms; and the plurality of object sub-platforms each comprise a gas meter;
each of the user sub-platforms is configured to initiate an overdrawing request to one of the plurality of service sub-platforms; and each of the gas meters is configured to send the overdrawing request to one of the plurality of sensor network sub-platforms; and
the management platform is configured to obtain the overdrawing request from one of the plurality of service sub-platforms or from one of the plurality of sensor network sub-platforms, query the credit of a user according to the overdrawing request and determine an overdrawn amount, and send the overdrawn amount to a gas meter corresponding to the overdrawing request via one of the plurality of sensor network sub-platforms.

7. The IoT system according to claim 6, wherein each of the gas meters is further configured to feed, upon the reception of the overdrawn amount, a confirmation message to the management platform via one of the sensor network sub-platforms.

8. The IoT system according to claim 7, wherein the plurality of service sub-platforms comprise operator service platforms and a recharge platform; and the management platform is further configured to obtain a payment amount according to the credit and the overdrawn amount, and send the credit, the overdrawn amount and the payment amount to a user sub-platform corresponding to the overdrawing request via the plurality of operator service platforms; and
each of the user sub-platforms is further configured to contribute the payment amount via the recharge platform within a preset time.

9. The IoT system according to claim 6, wherein each of the user platforms is specifically configured to initiate the overdrawing request to one of the plurality of service sub-platforms via an Application (APP) according to an operation instruction of a user, the overdrawing request comprising an Identification (ID) number of a gas meter of which the gas fee needs to be overdrawn and identification information of the user.

10. The IoT system according to claim 6, wherein the plurality of gas meters are further respectively and electrically connected with a card reader or a fingerprint recognition device; the card reader and the fingerprint recognition device are configured to verify the identity information of the user; a user initiates an instruction to a gas meter by swiping a card on a card reader or performing fingerprint verification on a fingerprint recognition device; and the gas meter initiates an overdrawing request to one of the plurality of sensor network sub-platforms, the overdrawing request comprising an ID number of the gas meter and identity information of the user.
